(19) United States
(12) Patent Application Publication
(10) Pub. No.: US 2015/0326287 A1
(43) Pub. Date: Nov. 12, 2015

(54) Systems and Methods for Improving Uplink Transmission Properties in a Communication Network

(71) Applicant: TELEFONAKTIEBOLAGET L M ERICSSON (PUBL), Stcokholm (SE)

(72) Inventors: Muhammad Kazmi, Bromma (SE); Jocelyn Aulin, Västra Frölunda (SE); Aurelian Bria, Nacka (SE)

(73) Assignee: Telefonaktiebolaget L M Ericsson (publ), Stocklolm (SE)

(21) Appl. No.: 14/440,771

(22) PCT Filed: Oct. 18, 2013
(86) PCT No.: PCT/SE13/51219

§ 371 Date: May 5, 2015

Related U.S. Application Data
(60) Provisional application No. 61/726,397, filed on Nov. 14, 2012.

(51) Int. Cl. H04B 7/04; H04W 72/04

(52) U.S. Cl. CPC H04B 7/0456; H04W 72/0413

(57) ABSTRACT

Embodiments are directed to improving uplink transmission properties in a communication network. In one aspect a method for improving uplink transmission properties is disclosed that includes: obtaining information indicating an operating scenario of a UE, wherein the UE includes a plurality of antennas and the UE is configured to transmit UL signals using the plurality of antennas; selecting a precoder that is optimized for UL multiple antenna transmission based on at least the indicated operating scenario; and communicating the precoder to the UE. The information indicating an operating scenario comprises information indicating one or more of: i) a deployment characteristic on which the UE operates, ii) a cell change scenario, iii) a radio transmission characteristic of the UE, iv) a number of links that are involved in UL transmissions from the UE, and v) a type of service used by the UE.

### TECHNICAL FIELD

Aspects of this disclosure relate generally to improving uplink data transmission on communication networks and more particularly, to systems and methods for improving such transmission properties by the selection of an optimal precoder for uplink transmissions in a multi-antenna environment.

### BACKGROUND

I. Multiple Antennas

A typical user equipment (UE) (e.g., mobile telephone, personal digital assistant, electronic reader, portable electronic tablet, personal computer, laptop computer, smartphone, or other communication device capable of wireless communication) comprises a single uplink transmit antenna that may be used for all types of uplink transmission. However, high-end UEs may have, and use, multiple uplink transmit antennas for uplink transmission. This is commonly referred to as “uplink transmit diversity.” An objective of transmit diversity transmission is to achieve higher uplink data rates, while achieving lower UE transmission power, through the use of spatial, angular and temporal diversities.

3GPP Long Term Evolution (LTE) is a standard for network technology, and is a technology for realizing high-speed packet-based communications that can reach high data rates on both the downlink (DL) and uplink (UL). Uplink transmit diversity is a type of UL multi-antenna transmission that has been specified for LTE and is being specified for High Speed Packet Access (HSPA) in Release 11. Presently, the most common uplink transmit diversity consists of two uplink transmit antennas. In this configuration, the signals from two or more uplink transmit diversity antennas may be transmitted in a different manner by adjusting their phase, amplitude, power etc. Exemplary uplink diversity schemes include: Transmit beamforming open loop; Transmit beamforming closed loop; Switched antenna uplink transmit diversity open loop; Switched antenna uplink transmit diversity closed loop; and Space time transmit diversity.

In certain respects, transmit diversity can be regarded as a special case of a multiple input multiple output (MIMO) transmission scheme, which can also be used in uplink transmissions.

The MIMO scheme is an advanced antenna technique used to improve spectral efficiency, thereby boosting the overall system capacity. Use of the term MIMO often implies that both the base station and the UE employ multiple antennas. MIMO techniques are widely studied and applied in practice for downlink communications, i.e., from the base station to the user equipment. Irrespective of the specific MIMO technique, the notation (m×n) is generally used to represent MIMO configuration in terms of a number of transmit (m) and receive antennas (n). Exemplary MIMO configurations presently used or discussed for various technologies include: (2×1), (1×2), (2×2), (4×2), (8×2) and (8×4). The configurations represented by (2×1) and (1×2) are special cases of MIMO and they correspond to transmit diversity and receiver diversity, respectively. The configuration (2×2) will likely be used in WCDMA release 7. MIMO technology has also been widely adopted in other wireless communication standards, such as IEEE802.16.

The above-mentioned MIMO modes, as well as other MIMO techniques not discussed herein, enable some amount of spatial processing of the transmitted and received signals. The resultant spatial diversity generally improves spectral efficiency, extends cell coverage, enhances user data rate, and mitigates multi-user interference, as well as providing additional benefits. However, each MIMO technique may be particularly well suited to offer certain benefits. For instance, the receiver diversity achieved in a (1×2) configuration is particularly effective to improve coverage. Alternatively, a (2×2) MIMO configuration, such as D-TxAA, may lead to increased peak user bit rate. Under ideal circumstances, a (2×2) MIMO scheme could double the data rate. However, the possibility of doubling the data rate depends on whether the channel is sufficiently uncorrelated so that the rank of the (2×2) MIMO channel matrix is 2 (the “rank” may be understood as the number of independent rows or columns of the matrix). In practice, the average data rate will be somewhat lower than 2 times the data rate achieved in single link conditions.

In a MIMO or transmit diversity scheme, a set of parameters related to MIMO or uplink transmit diversity are regularly adjusted by the UE. The objective of these adjustments is to ensure that the uplink transmission incorporates the desired spatial, temporal or angular diversities of the applicable technique in order to improve uplink coverage, reduce interference, increase uplink bit rate and enable the UE to lower its transmitted power, while maintaining the data throughput. Exemplary MIMO or transmit diversity parameters include: relative phase, relative amplitude, relative power, relative frequency, timing, and absolute or total power of signals transmitted on transmit diversity branches. The choice of all or a sub-set of these parameters is a part of, for instance, the implementation of a transmit beamforming scheme.

The objective of beamforming is to direct the uplink transmission (or “beam”) towards the desired base station, which is generally the serving base station. This allows the serving base station to decode the received signal more easily. Furthermore, the high directivity of the beam towards the desired base station reduces the interference experienced by neighboring base stations. Similarly, in the case of switched antenna transmit diversity, a transmit diversity parameter implies the selection of the most appropriate transmit antenna (e.g. in terms of radio condition) out of the available transmit diversity branches. By using the most appropriate antenna diversity configuration for the uplink transmission, the UE can either reduce its power while retaining a given uplink information rate, or increase the information rate while retaining a given output power.

In open loop MIMO or transmit diversity schemes, the UE autonomously adjusts the uplink transmit diversity parameters, based on the measurements on the received signal from serving base station and without the use of control signaling or commands transmitted by the network. These schemes are simpler, although they may not show substantial gain in all scenarios.

However, in closed loop MIMO or transmit diversity schemes, the UE adjusts the uplink transmit diversity parameters by making use of certain network transmitted control signaling or commands. The commands or control signaling may reflect the uplink quality, e.g. the quality measured at the base station, and are signaled to the UE over the downlink. Furthermore, the commands and control signaling can be sent exclusively to the UE to enable it to adjust the uplink transmit diversity parameters. Alternatively, the UE can utilize any existing commands or signaling, which may be originally intended for other purposes. Examples of implicit signaling or commands are transmit power control (TPC) commands and HARQ ACK/NACK, which are sent to the UE by the base station for uplink power control and uplink HARQ retransmission, respectively. The closed loop schemes have the potential to lead to a larger performance gain than closed loop implementations.

One of ordinary skill in the art will recognize that MIMO, or any transmit diversity scheme, can be used in any technology including LTE, Wideband Code Division Multiple Access (WCDMA), or even Global System for Mobile Communications (GSM). For instance, switched antenna uplink transmit diversity is standardized in LTE Release 8.

II. MIMO for Uplink Transmissions

The above-identified MIMO techniques are considered only for downlink transmission. The reason is that MIMO techniques may involve a higher level of complexity, both in the transmitter and in the receiver, when compared to SISO type of transmissions. On the RF side, in the transmitter, several power amplifiers may be needed depending on the MIMO scheme and on the number transmit antennas. In the receiver, multiple antennas are necessary as well as the fact that multiple RF chains may be needed depending on the MIMO scheme. Moreover, each MIMO scheme introduces additional complexity in the baseband processing.

While multiple power amplifiers are considered feasible in the base station because the base station has less constrains on form factor and battery life, if MIMO is to be used in uplink transmission, special consideration should be given to the use of (possibly multiple) power amplifiers, and effects on battery life. MIMO in uplink will have an impact on battery life, form factor and complexity, hence it is important to fully exploit the benefits that these techniques can provide. As in the downlink, different possible techniques can be applied in the uplink, such as beamforming or antenna switching. Depending on whether the receiving base station is equipped with multiple receiving antennas, it may be applicable to implement transmit diversity (2 transmit antennas, 1 receiving antenna) or Uplink-MIMO (2×2).

Recently 3GPP has started the work on uplink transmit diversity for Rel-11 UTRA systems and on uplink MIMO for Rel-11 E-UTRA systems. In the future, the extension of the transmit diversity scheme to more evolved uplink MIMO schemes will be defined for UTRA as well as for E-UTRA.

III. UE and Base Station ULTD and MIMO Capabilities

UL and DL Transmit Diversity and MIMO may be understood generally as a UE capability since they lead to significantly better performance when compared to the baseline scenario (single transmit and receive antenna). Therefore, a UE supporting uplink transmit diversity (ULTD) and/or MIMO capabilities may inform the network of its capabilities at the time of call setup or during the registration process. Certain technology may support more than one MIMO mode. For instance, a particular base station may support all possible MIMO modes allowed by the corresponding standard. In another scenario, the base station may offer only a sub-set of MIMO modes, or in a very basic arrangement the base station may not offer any MIMO operation, i.e., it supports only single transmit antenna techniques. Therefore, the actual use of a particular MIMO technique is possible in scenarios when both the serving base station and UE bear the same MIMO capability. The UL and/or DL MIMO can also work in conjunction with multi-carrier deployments. The MIMO with multicarrier is a different type of UE capability reported to the network.

IV. Precoding Information for UL Multiple Antenna Transmission

In general, precoding information enables the UE to set the amplitude and phases of the transmitted signal. More specifically, the UE uses a suitable precoding vector for transmitting a transport block or a data block on the UL physical channel, such as E-DPDCH in HSPA or PUSCH in LTE, using multiple streams for closed loop transmit diversity (CLTD) or UL MIMO. The terms transmit precoding vector, precoding vector, precoding codebook, precoding matrix, precoding signature, or simply codebook are interchangeably but bear the same meaning. A set of precoding vectors are pre-defined and are identified by an indicator (a.k.a., identifier) (e.g., an index), e.g., transmit precoding indicator (TPI). An indicator is used to reduce signaling overheads instead of signaling the entire precoding vectors to the UE. Generic terms such as “precoding vector” and “precoding indicator” or simply “precoder” are used herein but they cover all types of examples mentioned above, including indications of a precoder.

A suitable precoder is determined by the serving radio node of the UE. Presently, the determination is typically based on UL pilot or sounding signals sent by the UE to the node. The determined precoder is one of the pre-determined vectors. The network sends the identifier of the selected precoder to the UE. The signaled information about the selected precoder is termed a transmit precoding indicator (TPI) in HSPA or a precoding matrix indicator (PMI) in LTE.

V. Heterogeneous Network Deployment

Certain networks may include both low and high power nodes, which may operate on the same or different carrier frequencies. These networks are referred to as “heterogeneous networks.” The low power nodes (LPNs), also called micro, pico and femto or home base stations, typically have a significantly lower coverage area than the high power nodes. An example of high power node is a node serving a wide area such as macro cell. To mitigate interference in heterogeneous networks, time domain enhanced inter-cell interference coordination ICIC (eICIC) has been specified in release 10 for LTE. According to the time domain eICIC scheme, a time domain pattern of low interference subframes, otherwise known as a “low interference transmit pattern,” is configured for the aggressor node, such as a macro eNodeB. Interference mitigation patterns may be referred to as Almost Blank Subframe (ABS) patterns.

VI. UE Measurements

In WCDMA single carrier systems, the following three exemplary UE (downlink) serving and neighbor cell measurements are specified primarily for mobility purpose: i) Common Pilot Channel (CPICH) Received Signal Code Power RSCP; ii) CPICH Ec/No; CPICH Ec/No=CPICH RSCP/carrier Received Signal Strength Indicator (RSSI); and iii) UTRA Carrier RSSI.

The RSCP is measured by the UE on the cell level basis on the common pilot channel (CPICH). The UTRA carrier RSSI is measured over the entire carrier. It is the total received power and noise from all cells (including serving cells) on the same carrier. The above CPICH measurements are the main quantities used for the mobility decisions.

In E-UTRAN the following two exemplary downlink serving and neighbor cell measurements are also specified for mobility purposes: Reference symbol received power (RSRP); and Reference symbol received quality (RSRQ): RSRQ=RSRP/carrier RSSI The RSRP or RSRP part in RSRQ in E-UTRAN is solely measured by the UE on the cell level basis on reference symbols. The E-UTRA carrier RSSI is measured over the configured measurement bandwidth up to the entire carrier bandwidth. It is also the total received power and noise from all cells (including serving cells) on the same carrier. The two reference signal based measurements are likely to be used for mobility decisions.

VII. Positioning Overview

Several positioning methods for determining the location of a target device exist, which can be, for example, any of a wireless device or UE, mobile relay, or PDA. The position of the target device is determined by using one or more positioning measurements, which can be performed by a suitable measuring node or device. Depending upon positioning, the measuring node can either be the target device itself, a separate radio node (i.e. a standalone node), serving and/or neighboring node of the target device, etc. Also, depending upon the positioning method, the measurements can be performed by one or more types of measuring nodes.

Well known positioning methods include: satellite based methods, observed time difference of arrival (OTDOA), uplink-time difference of arrival (U-TDOA), Enhanced Cell Id, and hybrid methods.

In satellite based methods, measurements performed by the target device on signals received from the navigational satellites are used to determine the target device's location. For example either GNSS or A-GNSS, such as A-GPS, Galileo, COMPASS, or GANSS, measurements are used for determining the UE position. The OTDOA method uses UE measurements related to the time differences of arrival of signals from radio nodes (e.g. UE RSTD measurement) for determining UE position in LTE or SFN-SFN type 2 in HSPA. The U-TDOA method uses measurements done at a measuring node (e.g. LMU) on signals transmitted by a UE. The LMU measurement is used for determining the UE position. The Enhanced cell ID method uses one or more of measurements for determining the UE position, including any combination of UE Rx-Tx time difference, BS Rx-Tx time difference, timing advanced (TA) measured by the BS, LTE RSRP/RSRQ, HSPA CPICH measurements (CPICH RSCP/Ec/No), angle of arrival (AoA) measured by the base station on UE transmitted signals, among others, for determining UE position. The TA measurement is done using use either UE Rx-Tx time difference or base station Rx-Tx time difference or both. Hybrid methods rely on measurements obtained using more than one positioning method.

For instance, in LTE the positioning node (e.g., E-SMLC or a location server) configures the UE, base station (e.g., eNode B) or LMU to perform one or more positioning measurements depending upon the positioning method. The positioning measurements are used by the UE or by a measuring node or by the positioning node to determine the UE location. In LTE, the positioning node communicates with UEs using the LPP protocol and with the eNode B using the LPPa protocol.

VIII. Multi-Carrier or Carrier Aggregation Concept

To enhance peak-rates within a technology, multi-carrier or carrier aggregation solutions may be used. Each carrier in a multi-carrier or carrier aggregation system is generally termed as a component carrier (CC) or sometimes it is also referred to as a cell. A component carrier (CC) may be understood as an individual carrier in a multi-carrier system. The term carrier aggregation (CA) is also referred to as a “multi-carrier system,” “multi-cell operation,” “multi-carrier operation,” “multi-carrier” transmission and/or reception. The CA is used for transmission of signaling and data in the uplink and downlink directions. One of the CCs is the primary component carrier (PCC), and may be referred to simply as the primary carrier or even the anchor carrier. The remaining CCs are called secondary component carriers (SCCs) or simply secondary carriers, or even supplementary carriers. Generally the primary or anchor CC carries the essential UE specific signaling. The primary CC carriers the control and data. The SCC carriers typically only carry user data. Therefore, the PCC exists in both the uplink direction for UL control and data and as well as in the DL direction, when the UE is configured in CA. The network may assign different primary carriers to different UEs operating in the same sector or cell.

Therefore, a UE may have more than one serving cell in downlink and/or in the uplink: one primary serving cell and one or more secondary serving cells operating on the PCC and SCC respectively. The serving cell is interchangeably called the primary cell (PCell) or primary serving cell (PSC). Similarly the secondary serving cell is interchangeably referred to as the secondary cell (SCell) or secondary serving cell (SSC). Regardless of the terminology, the PCell and SCell(s) enable the UE to receive and/or transmit data. More specifically, the PCell and SCell exist in both the DL and UL for the reception and transmission of data by the UE. The remaining non-serving cells on the PCC and SCC are called neighbor cells.

The CCs belonging to the CA may belong to the same frequency band (intra-band CA) or to different frequency band (inter-band CA) or any combination thereof (e.g. two CCs in band A and one CC in band B). Furthermore the CCs in intra-band CA may be adjacent or non-adjacent in frequency domain (intra-band non-adjacent CA). A hybrid CA comprising of intra-band adjacent, intra-band non-adjacent and inter-band is also possible. Using carrier aggregation between carriers of different technologies is also referred to as “multi-RAT carrier aggregation” or “multi-RAT-multi-carrier system” or simply “inter-RAT carrier aggregation.” For example, the carriers from WCDMA and LTE may be aggregated. Another example is the aggregation of LTE and CDMA2000 carriers. For the sake of clarity the carrier aggregation within the same technology may be regarded as ‘intra-RAT’ or simply ‘single RAT’ carrier aggregation.

The CCs in CA may or may not be co-located in the same site or base station or radio network node (e.g. relay, mobile relay etc). For instance the CCs may originate (i.e. transmitted/received) at different locations (e.g. from non-located BS or from BS and RRH or RRU). Certain well known examples of combined CA and multi-point communication are DAS, RRH, RRU, CoMP, multi-point transmission/reception etc. This disclosure also applies to the multi-point carrier aggregation systems. The multi-carrier operation may also be used in conjunction with multi-antenna transmission. For example signals on each CC may be transmitted by the eNB to the UE over two or more antennas.

IX. Multipoint Operation

In multipoint operation, more than one radio link serves the UE. Each radio link can be viewed as a transmission from a cell. Multipoint operation may be understood as covering reception of data through multiple links at the UE from two or more radio nodes and/or reception of data through multiple links at two or more radio nodes. The radio links typically belong to different cells, which may be served by the same site or different sites. Commonly used terms for multipoint operation are coordinated multi-point (CoMP), multi-cell or multi-point transmission, multi-cell or multi-point transmission and/or reception, and multipoint HSDPA, among others. Multipoint operation is used in HSPA and LTE. In LTE, DL CoMP typically includes multiple geographically separated transmission points that dynamically coordinate their transmission. The UE may combine the received signals depending upon the reception scheme used at the UE or configured by the network.

### SUMMARY

Described herein are various embodiments for improving uplink transmission properties in a radio network serving one or more UEs that are configured to transmit UL signals with multiple antennas using, for example, CLTD or MIMO techniques. These embodiments may be used over multiple cells or radio links, for example, with softer or soft handover for WCDMA, UL CoMP in LTE, a HNET scenario, or UL carrier aggregation.

According to certain embodiments, a method for improving UL transmission in a communication network includes obtaining, at a network node (e.g., a base station serving a UE), information indicating an operating scenario of the UE served by the network node, wherein the UE includes a plurality of antennas and the UE is configured to transmit UL signals using the plurality of antennas. The method also includes selecting a precoder that is optimized for UL multiple antenna transmission based on at least the indicated operating scenario. The method further includes communicating the precoder to the UE. The information indicating an operating scenario comprises information indicating one or more of: i) a deployment characteristic on which the UE operates, ii) a cell change scenario, iii) a radio transmission characteristic of the UE, iv) a number of links that are involved in UL transmissions from the UE, and v) a type of service used by the UE.

In some embodiments, the step of selecting a precoder includes or consists of one or more of: choosing a precoder, determining a precoder, and updating a precoder or otherwise adapting a precoder. This selected precoder is signaled to the UE, thereby enabling the UE to improve uplink performance. The selection and/or signaling of a precoder may encompass not only the selection and/or signaling a precoder itself, but also the selection and/or signaling of a precoding indicator, such as TPI or PMI. Accordingly, when this disclosure, for example, refers to signaling or otherwise communicating a precoder to a UE, this means sending to the UE the precoder and/or a precoding indicator that identifies the precoder. The disclosed methods may be performed, for instance, by a network node such as base station (e.g., a Node B, eNode B) or relay.

According to further aspects of the disclosure, a system and method is provided for a network node serving a UE configured for transmitting UL signals using UL multi antennas over multiple cells or radio links, which selects a subset of cells or base stations from a set of cells or base stations. This subset of cells or base stations are considered for optimized selection of the precoder (e.g. TPI or PMI) used by the UE for uplink multi-antenna transmissions. The method further includes determining the precoder based on one or more criteria of the selected subset of cells, and signaling the selected precoder to the UE to be used for UL multi-antenna transmission. The terms select, determine, choose, and the like may be used interchangeably herein without loss of generality or waiver.

Certain embodiments disclose a user equipment (UE) operable in a communication network including one or more network nodes. The UE comprises a plurality of transmit antennas (e.g., two or more) and a processor. The processor is configured to receive from at least one of the one or more network nodes a precoder for use in uplink multiple antenna transmissions from the UE, wherein said precoder is based on one or more operating scenarios of the UE. The UE applies the precoder to an uplink data transmission and transmits it from the plurality of transmit antennas.

According to certain embodiments, methods for selecting and signaling optimized precoders may be implemented in a node, such as a macro base station. Disclosed systems and methods may be used to overcome the deficiencies of present techniques. Examples of these deficiencies are detailed below:

According to the 3GPP standard, when a UE is configured to operate using UL CLTD or UL MIMO in a baseline single uplink scenario, or in a scenario involving multiple uplinks (e.g. in soft handover for HSPA or UL CoMP for HSPA or LTE), the UE's serving or primary serving radio network node (e.g. base station, relay etc.) chooses precoding related information, such as transmitted precoding indicator (TPI) in HSPA or precoding matrix indicator (PMI) for LTE, and signals it to the UE. The UE then uses the received UL precoding information from its serving radio network node for uplink transmission with beamforming. This precoding information can be especially detrimental to the secondary serving radio network node involved in multiple uplinks. This leads to sub-optimal demodulation performance of uplink received signals at one or more of the secondary radio network nodes. However, when a UE is connected via multiple links to one or more cells, for instance, in soft handover, UL CoMP, UL multiflow transmission, the selection of the precoding indicator (e.g. TPI in HSPA or PMI in LTE) at the serving radio node may not be the best choice for overall uplink operation, if the selection is based only on the channel estimation on the link connected to the serving radio node or primary serving radio node.

For instance, 3GPP TS 25.214 v11.3.0, Section 10 provides that “Upon higher layer signaling that do not result in a serving cell change, the UE shall remember its current UL CLTD activation state and use the last received pre-coding vector after the RRC reconfiguration. Upon higher layer signaling that result in serving cell change, CLTD activation state is either reset or maintained in the RRC reconfiguration message. If activation state 1 is configured, the TPI is initially set to the fixed precoder weight corresponding to the bit pattern “1100” in Table 10.” In this case, when the UE changes serving cell change signal, the precoder weight is again reset to “1100”, which is arbitrary. (See FIG. 2, which illustrates a UE 102 communicating over multiple links (e.g., link 204 and link 205) of multiple sector cells of a macro cell base station 206 in a softer handover scenario (WCDMA), and FIG. 3, which illustrates a soft handover scenario (WCDMA) and shows UE 102 communicating over multiple links (e.g, link 304, link 305, link 308, and link 307) of multiple cells of different macro cell base stations 306a, 306b, 306c, 306d. Hence, re-setting the TPI arbitrarily to an initial value may result in suboptimal demodulation performance.

A solution to this problem, provided by the systems and methods disclosed herein, is to setup TPI prior to cell change, so that the UE can continue to re-use the last TPI received. There are only 4 TPI values to choose from. In order to choose the best one, the base station will try all four of these values on the signal received from UL and select the one that produces the largest Signal to Interference plus Noise Ratio (SINR).

3GPP TS 25.214 v11.3.0, Section 10.2, provides that “If UL_CLTD_Enabled is TRUE and UL_CLTD_Active is 1, the base station (e.g., Node B) determines a precoding phase which is signaled to the UE using the allocated TPI field on the F-TPICH as defined in 3GPP TS 25.214 v11.3.0; see also Table 10. The following applies: if the UE is configured with an HS-DPCCH, the F-TPICH can be transmitted either from the HS-DSCH serving cell only or from all the cells in the serving radio link set; if the UE is not configured with an HS-DPCCH, higher layers indicate to the UE which cells in the active set transmit the F-TPICH, with the restriction that either only one cell transmits the F-TPICH or all cells from one radio link set transmit the F-TPICH.”

3GPP TS 25.214 v11.3.0, Section A.2, provides that “in non-soft handover case, the computation of feedback information can be accomplished by e.g. solving for weight vector, w, that maximizes

P=w^{H}H^{H}Hw (1)

where

H=[h₁h₂] and w=[w₁,w₂]^{T} (2)

and where the column vectors h₁ and h₂ represent the estimated channel impulse responses for the transmission antennas 1 and 2, of length equal to the length of the channel impulse response. The elements of w correspond to the adjustments computed by the UE.”

A deficiency with the above technique is that the TPI selected is based only on the single link and only based on maximizing the received power over that link which connects the UE to the base station in the given cell. (See FIG. 1, which illustrates UE 102 that communicates over a single link 104 within a single cell 105 of a macro cell base station 106). It does not take into account the opportunity to reduce interference that the UE causes to other cells in the network or other UEs in the same cell. In scenarios where interference is the dominant problem, the TPIs of UEs should be selected to address this. A solution to this problem is provided by the systems and methods disclosed herein, by selecting TPIs to minimize interference within cell and to other cells in the network in a softer handover case.

3GPP TS 25.214 v11.3.0, Section 10.3, provides that “When a UE is in softer handover and if F-TPICH is transmitted from multiple radio links as defined in sub-clause 10.2, the UE may assume that the transmitted TPI bits from those radio links in a TPI combining period are the same. The TPI combining period has the length of one slot, beginning at the downlink slot boundary of the F-TPICH. Upon reception of one or more TPI bits in a TPI combining period, the UE combines all the TPI bits received in that TPI combining period into a single TPI bit.” In this case, the same TPI bits can be sent from the serving cell as well as from other cells. (See FIG. 2). However, the TPI is chosen only by the serving base station based on measurements on the serving link. The other cells participating in the softer handover may face a suboptimal demodulation performance due to the fact that the UE is using the TPI determined and based only on the serving link.

Given that UL MIMO operates with CLTD on commonality basis, the problems identified above also apply to UL MIMO.

Another problem with existing solutions occurs in a heterogeneous network scenario involving, for example, in the simplest case a macro cell and a small cell. (See FIG. 4, which illustrates UE 102 communicating with both a macro cell base station 406 and the small cell base station 409 in a heterogeneous network (HNET) scenario). When a UE is near or within a region close to the border between a macro cell and small cell, there is an imbalance of base station received powers between that for the link 405 from UE 102 base station 409 and that for the link 404 from UE 102 base station 406, given that UE is connected to both cells. The signal arriving at the macro cell base station is much weaker than that arriving at the small cell base station, significantly jeopardizing the reliability of the received signal at the macro cell base station. However, the UE is constrained from increasing its transmission power, since if it does, it will result in additional interference to other UE signals in the small cell. This, and other deficiencies of existing solutions, are addressed by the systems and methods disclosed herein.

The disclosed systems and methods enable the network to efficiently use UL MIMO in a wide range of radio network operating scenarios (e.g. multi-cell, multi-link, under cell change etc.) by adapting the precoder used by the UE for UL MIMO. Interference is reduced in the network since antenna directions can be optimized to lower the overall interference towards neighboring base stations. Further, UE performance is enhanced in terms of UE uplink throughput, enabling the UE to reduce its transmitted power by focalizing the RF energy in the right direction(s), which in turn also reduces UL interference, and enabling the UE to save its battery power since average UE transmitted power is reduced.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments.

FIG. 1 is a diagram of a communication network.

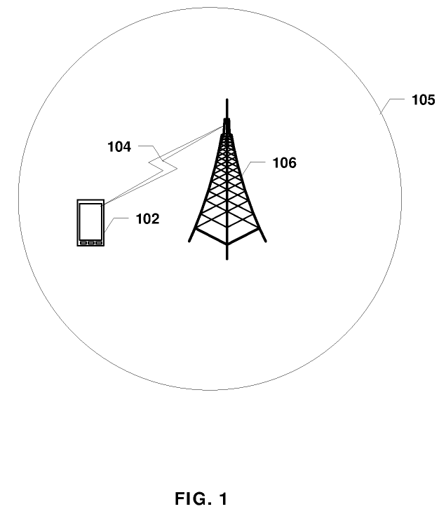

FIG. 2 is a diagram of a communication network.

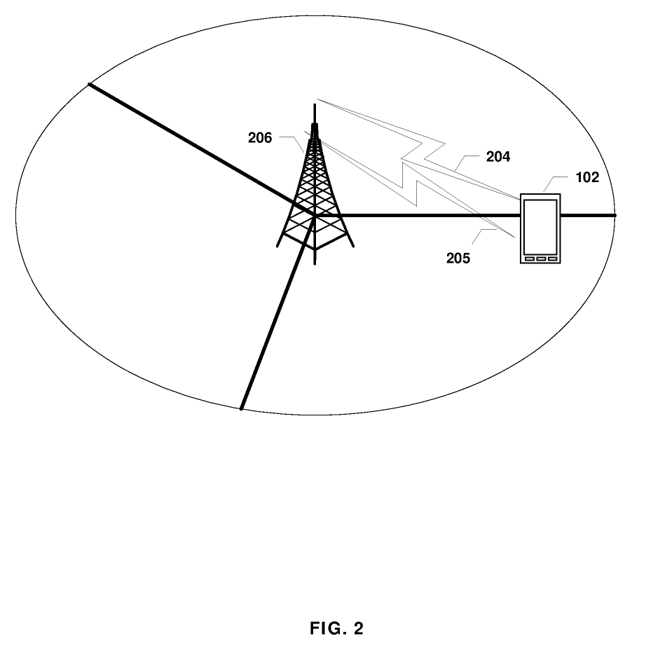

FIG. 3 is a diagram of a communication network.

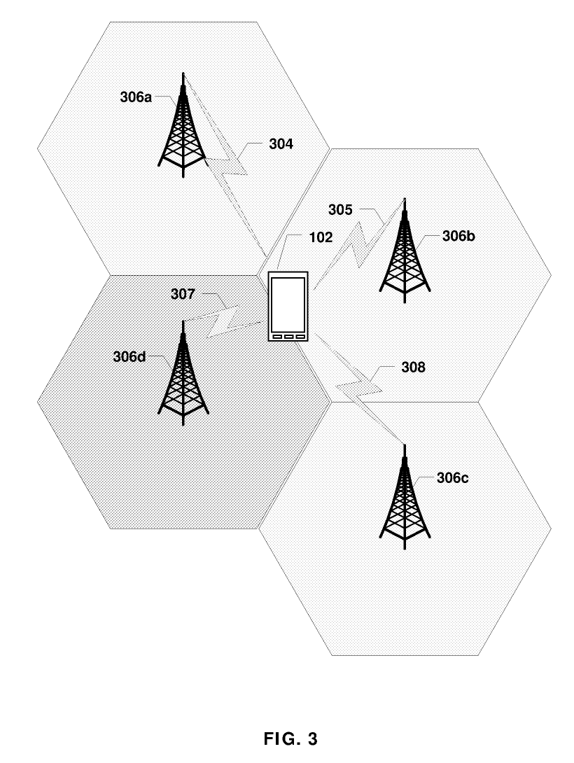

FIG. 4 is a diagram of a communication network.

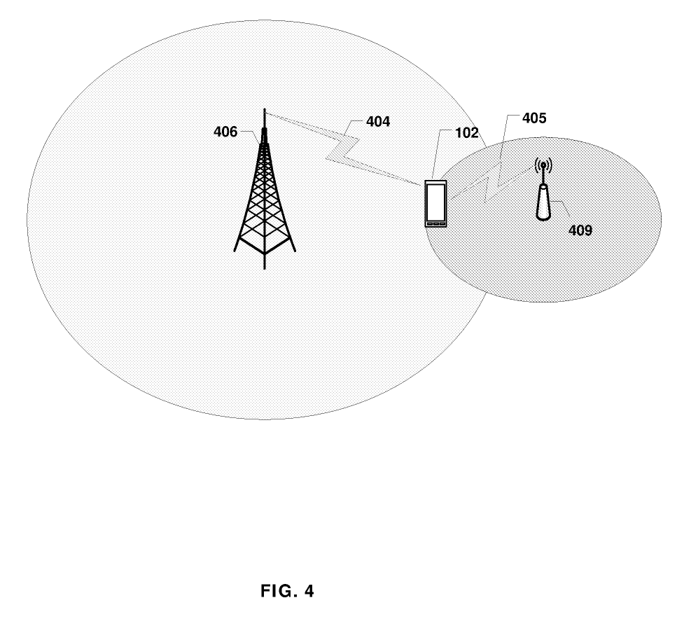

FIG. 5 is a flow chart illustrating a process according to certain embodiments.

FIG. 6 is a flow chart illustrating a process according to certain embodiments.

FIG. 7 is a flow chart illustrating a process according to certain embodiments.

FIG. 8 is a flow chart illustrating a process according to certain embodiments.

FIG. 9 is a flow chart illustrating a process according to certain embodiments.

FIG. 10 is a flow chart illustrating a process, according to some embodiments, that is performed by a UE.

FIG. 11 is a block diagram of a network node according to some embodiments.

FIG. 12 illustrates software modules of a network node according to some embodiments.

FIG. 13 is a block diagram of a UE according to some embodiments.

FIG. 14 illustrates software modules of a UE according to some embodiments.

### DETAILED DESCRIPTION

According to some aspects of the disclosure, a network node serving a UE that is configured for UL multi-antenna transmission over more than one radio link (e.g. soft handover, UL CoMP, or multi-cell operation) acquires information related to the operating scenario in which the UE, serving cell and one or more neighboring cells operates; selects a precoder configuration for UL transmission depending upon the operating scenario; and informs the UE about the selected precoder configuration. The UE may then use the chosen precoder for uplink transmission using multiple antennas over more than one radio link.

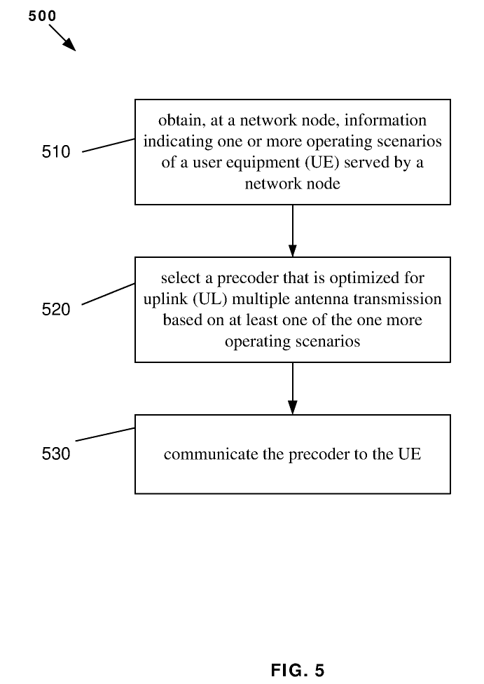

Referring now to FIG. 5, a flow chart illustrating a process 500 performed by a network node (e.g., network node 1100) for improving uplink transmission properties in a communication network is shown. In certain instances, the process 500 may be applied in a scenario where a UE includes multiple antennas and is configured to transmit uplink (UL) signals from a plurality of the multiple antennas to the network node.

In step 510, the network node obtains information indicating one or more operating scenarios of a UE, for instance, with respect to the radio links or cells in which the UE operates. This information may be obtained (e.g., received and/or determined) by the network node, which may be in communication with the UE. This network node may be the UE's serving node. Operating scenarios may include, for example, deployment characteristics of the radio links/cells on which the UE operates, cell change scenarios, and the UE's radio transmission characteristics. The network may also keep track of changes in the operating scenario of the UE over time.

Deployment characteristics of radio links/cells on which a UE operates can be determined or obtained based on pre-defined knowledge about nodes, and can be stored in the network node. For instance the network node can store the deployment characteristics of one or more (or all) neighboring cells, along with their cell IDs. Exemplary deployment characteristics may include, but are not limited to, the cell size of cells serving the UE, radio requirements (e.g. receiver sensitivity) of radio nodes serving the UE, and power class or power levels (also known as base station classes) of radio nodes serving the UE.

An exemplary cell change scenario is when the serving cell of a UE will change or is expected to change.

UE radio transmission characteristics may include, for instance, the UE's transmit power (e.g. from the power headroom report or UE transmit power measurement report) or the UE's battery power (e.g. available or remaining UE battery power). Certain characteristics can be acquired based on a UE's reported measurements and/or based on estimation performed at the network. For example, if a UE is operating over a certain time period with certain transmit power, the network can implicitly determine the amount of power consumed by the UE battery during the communication.

In step 520, the network node selects a precoder that is optimized for uplink (UL) multiple antenna transmission based on at least one of the one more of the received operating scenarios. In step 530, the network node communicates the precoder to the UE (e.g., the node sends to the UE a precoding indicator).

According to certain embodiments, a network node serving the UE, such as the primary serving node, selects the most suitable precoder for UL transmission for the UE when it is operating with multiple links, wherein the selection is based on the operating scenario of the UE. This is in contrast to the techniques employed by present network nodes, which do not take into account the operating scenario of the UE when selecting the precoder. Instead, the present network node mainly select the precoder based on the quality of the UL received signal, such as the signal to noise ratio (SNR) of the UL reference signal, UL sounding signals, or UL pilot signals. In the present disclosures, the selection of a precoder may be based on deployment characteristics, recognition of a cell change scenario, or analysis of a multiple cell/link environment.

In one embodiment of the disclosure, the serving radio node of the UE, which may be a base station, or any communication node, selects the precoder based at least in part on the fact that neighboring cells will experience different levels of interference depending upon the deployment characteristics of cells on which the UE is operating and the selected precoder. A goal of this embodiment is to reduce the uplink interference in at least some of the neighboring cells. More specifically, the precoder may be selected such that when a UE transmits with the selected precoder the received power at the receiver of small cells, such as the cells served by low power nodes, is reduced and received power at the large cells is increased. The lower power nodes may include, for example, micro, pico, and femto nodes while the larger cells may be, for example, macro cells or other cells served by a high power node. This may be achieved by selecting a precoder which enables more directive transmission to steer the direction of transmission towards the macro cell, for example, by using a precoder that ensures beamforming.

This method of selecting the precoder may be particularly useful when the UE is closer to the small cell's node, for instance, in the region close to the boundary between the macro cell and small cell. This scenario frequently occurs in a heterogeneous network, which contains cells served by low power nodes and high power nodes.

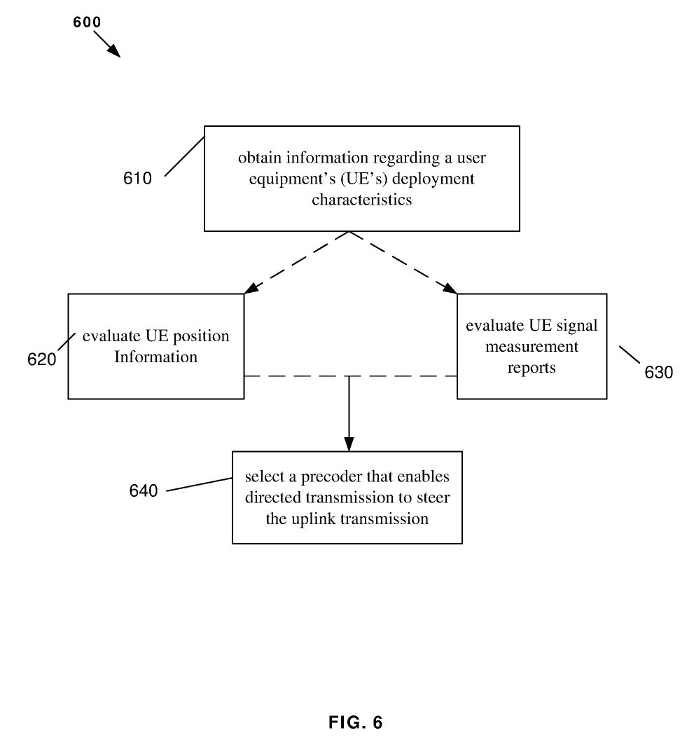

Referring to FIG. 6, a flow 600 illustrating a process for selecting a precoder based on deployment characteristics is shown. In step 610, information regarding the UE's deployment characteristics is received. According to certain aspects, this step may be the same as step 510 of flow 500.

The flow includes one or both of steps 620 and 630. Step 620 includes evaluating the UE's location with respect to the low and high power radio nodes. For example, this can be determined by the serving node using one or more known techniques, such as using existing positioning methods. In step 630, the node evaluates one or more signal measurement reports, such as CPICH RSCP, E/No measurements in HSPA, RSRP and RSRQ in LTE, UE Rx-Tx time difference, timing advance, etc. In step 640, the node selects a precoder that enables directed transmission to steer the uplink transmission of the UE.

When implemented in a WCDMA network, this approach can reduces the Rise over Thermal (RoT) for the small cell while at the same time, increasing the received signal strength at the base station in the macro cell. As a result, the number of UEs that can be supported in the small cell can be increased while simultaneously increasing the reliability of the UL signal received in the macro cell.

In certain aspects, the method for selecting the precoder (e.g. TPI) can be implemented according the following scheme, which can be implemented in a serving node, such as a base station. Although explained using the non-limiting example of WCDMA, one of ordinary skill in the art will readily recognize that the disclosed steps and features can be generalized to other systems, such as LTE.

An objective of this scheme is to select the TPI that maximizes the received power to the macro base station, subject to the constraint that the received power to the small cell base stations is above a given minimal level. For instance, the optimized TPI may be determined by solving the following expression:

$$arg ( f ( TPI ) ) = arg ( {max}_{TPI} {P}_{macro} ( TPI ) ) \qquad ( 1 )$$

subject to the constraint

Pₛₘₐₗₗ_{_{—}}_{cell}(TPI)≧thresholdₛₘₐₗₗ_{_{—}}_{cell} (2)

where P_{macro}(TPI) is the power of the received UE signal at the macro base station as a function of TPI, Pₛₘₐₗₗ_{_{—}}_{cell}(TPI) is the power of the received UE signal at the small cell base station as a function of TPI, the operator arg(−) gives the argument of the input function, and thresholdₛₘₐₗₗ_{_{—}}_{cell} is the minimal received power requirement at the small cell base station for acceptable demodulation performance of the received UE signal. In an implementation of the above scheme, the small cell base station will send to the macro base station, for instance via the backhaul, the transmitter precoding indicators (TPIs) that satisfy the above constraint equation (2), which are the feasible subset of TPIs. The macro base station will then determine the optimal TPI from the feasible subset of TPIs as informed by the small cell base station.

According to certain embodiments of the disclosure, a network node (e.g. base station, relay etc.) selects a precoder when a UE is performing, or is expected to perform, a cell change to a target cell. Examples of cell change scenarios include handover, cell reselection, RRC connection re-establishment, RRC redirection, primary serving cell change in multicarrier, primary serving carrier change in multicarrier, primary link or cell change in multipoint reception and/or transmission, and active set cell update in HSPA. This embodiment may be applicable when the serving cell of the UE is configured with a single cell/radio link or with multiple cells/radio links changes or is expected to change. The embodiment is particularly useful when the UE is configured with multiple links, for instance, in soft handover.

Aspects of certain disclosed embodiments ensure that a UE, when using multiple antennas, can continue transmitting signals in the uplink to the old and new serving cells and maintain communication with the new serving cell, without causing any interruption, delay or degradation of UL performance.

For example, prior to the cell change of a UE from a serving radio node to a target radio node, the target radio node can select the precoder (e.g. TPI) that the UE should use for uplink transmission. The target node may then indicate the precoder or associated information (e.g. identifier of a precoder) to the serving radio node. The serving node then signals this precoder to be used for uplink transmission with multiple-antennas in the target node when the target node becomes the new serving node of the UE. The target node can provide this precoder information (e.g. recommended TPI or PMI) to the serving radio node of the UE via an interface between the two radio nodes. In certain aspects, if the serving and target radio nodes are co-located (e.g. cells in the same base station site) then the target node can provide this information to the serving node via an internal communication link between the two nodes. In another example, the target node can send this information to the serving node via a backhaul communication link before the cell change. For instance, in LTE this information can be sent by the target node to the serving node over X2 between eNode Bs. In HSPA, this information can be sent by the target Node B of the UE to a radio network controller (RNC) via Iub. Then the RNC can send the acquired information to the serving Node B of the UE via Iub interface.

The serving radio node may send the acquired precoder information, which is associated with a target radio node (i.e. new serving cell), on the DL channel to the UE before the cell change. The serving node may also indicate that the precoder is associated with the UL transmission with multiple antennas towards another cell (e.g. target cell after cell change). Therefore the precoder information provided to the UE by the old serving cell may be tagged with a cell identifier of the target cell. The old serving node may also signal the precoder information associated with the UL transmission with multiple antennas to both cells, i.e. the serving node and target node. According to certain aspects, it may be pre-defined that when a UE receives more than the precoder information it will use the additional precoder information for UL transmission with multiple antennas to the target cell after the cell change.

For example, in HSPA, the UE will use this TPI immediately after handoff when transmitting in the new serving cell. This may be especially applicable when the UE is in a soft handover. This should prevent any delay in acquiring the TPI applicable for the new serving cell when the UE changes serving cells in the soft handover. In this way, the UE is already prepared and using a TPI, which may be termed a “destination TPI,” that is optimized for the destination base station or cell. Hence, when a handoff or cell change occurs, there is a reduced likelihood of degradation in the destination base station or cell's receiver demodulation performance immediately after handoff.

According to an aspect of the embodiment, the serving node receives precoder information only from one target node, such as the node that will be the new serving node after cell change, regardless of whether the UE is operating with one cell/link or more. In this case, the serving node sends the received precoder information to the UE, which is required to use it after the cell change as explained above.

According to another aspect of the embodiment, the serving node receives precoder information from more than one target node. These nodes may be involved in multi-cell/multi-link communication with the same UE, for instance, in soft handover or UL CoMP. In this case, a network node (e.g. RNC, base station, etc.) may derive one set of precoder information from the received precoder information of one or more of the neighboring nodes. The derived precoding information is then signaled to the UE by the current serving node to the UE, which uses it when transmitting with multiple antennas after the cell change.

An exemplary algorithm that may be used to derive one set of precoder information from multiple received precoder information is described below. Although explained using the non-limiting example of WCDMA, one of ordinary skill in the art will readily recognize that the disclosed steps and features can be generalized to other systems, such as LTE.

According to certain embodiments, a serving base station or the RNC of a UE acquires precoder information from its neighboring nodes. The neighboring nodes may be involved in SHO or multi-cell operation. The disclosed scheme can be implemented in the serving base station, RNC, or in any network node that can acquire the precoder information of many (or all) neighboring nodes. The scheme may even be implemented in the UE, where the serving node may signal the precoder information for all the nodes to the UE. For example, when the UE is in softer handover or in multicell operational mode the TPI or any precoding information for UL multi-antenna transmission can be sent from multiple DL radio links to the UE. The UE can apply the derived or received precoder information for the target cell after the cell change. This scheme will ensure that after a serving cell change when in SHO, or operating in a multi-cell operating scenario, the UE uplink transmission can be received by the new serving cell without performance degradation or with minimum performance loss.

The radio node (e.g. network node or UE) will derive the TPI for the UL transmission that achieves one or more objectives related to inter-cell interference mitigation. For example the aim of the selected TPI may be to reduce the interference to other base stations or cells, frequently termed “victim” base stations or cells, that do not have radio links established with the UE. That is, the TPI may be chosen so that minimum power is transmitted to the victim base stations or cells. In other words, the UE will not point the main lobe of the antenna towards the victim base station or cells in certain examples. This method can be implemented using the following scheme for selecting the TPI:

$$arg ( {f}_{2} ( TPI ) ) = arg ( {max}_{TPI} α {P}_{dest} ( TPI ) - β {\sum }_{i = 1}^{N} {P}_{victim\_i} ( TPI ) ) \qquad ( 3 )$$

where P_{dest}(TPI) is the power of the received UE signal at the destination base station or cell as a function of TPI, P_{victim}_{_{—}}ᵢ(TPI) is the power of the received UE signal at the i^{th} victim base station or i^{th} victim cell as a function of TPI, and α, β are scalar weights which represent the relative significance of the respective terms. An alternative implementation is the following scheme for selecting the TPI:

$$arg ( {f}_{2} ( TPI ) ) = arg ( {max}_{TPI} {P}_{dest} ( TPI ) ) , \qquad ( 4 )$$

subject to the constraints

P_{victim}_{_{—}}ᵢ(TPI)≦threshold_{victim}_{_{—}}ᵢ, i=1,2, . . . ,N (5)

where threshold_{victim}_{_{—}}ᵢ is the maximum tolerable level of interference power allowed at the i^{th} victim base station or cell, and N is the total number of victim base stations and cells. The schemes discussed herein can also be pre-defined, especially when implemented in the UE.

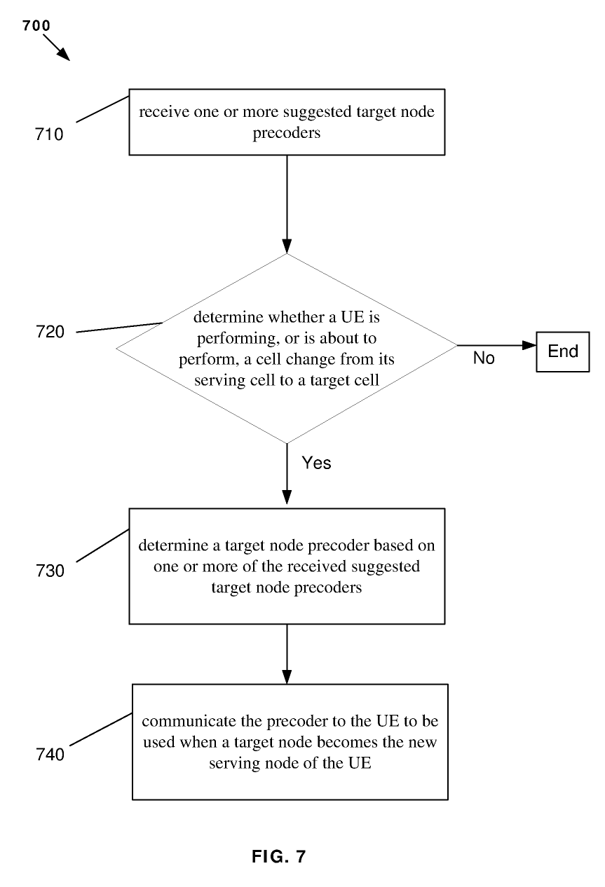

Referring now to FIG. 7, a flow 700 illustrating a process for selecting a precoder for a cell change is shown.

In step 710, the serving node receives one or more suggested target node precoders.

In step 720, the serving node determines (e.g., is informed) whether a UE is performing, or is about to perform, a cell change from its serving cell to a target cell. If the UE is performing, or is about to perform, a cell change the flow proceeds to step 730. That is, in some embodiments, step 730 is performed in response to a determination that a UE is performing, or is about to perform, a cell change from its serving cell to a target cell.

In the case of a cell change and where the serving node receives suggested precoders from multiple potential target nodes, in step 730, the node determines which target node precoder should be used based at least in part on the received suggestions.

In step 740, the precoder is communicated to the UE to be used when a target node becomes the new serving node of the UE.

According to certain embodiments of the present disclosure, when a UE does not perform a cell change and is operating with multiple cells (e.g. SHO, UL CoMP, multi-cell operation, etc.), the selection of the precoder configuration is made by taking into account the recommended precoder configuration not only at the serving (or primary) base station, but also at other nodes involved in the multi-cell operation.

In certain respects, the selection of the appropriate precoder, such as TPI, may be understood as an optimization problem that can have one or several objectives. Examples of possible objectives are: i) minimization of UE transmit power, or UE power consumption (can also target a group of UEs, not only one UE); ii) maximization of UE UL data throughput (can also target a group of UEs not only one UE); iii) minimization of interference to certain BS(s) or cells in the proximity of the UE; iv) other similar objectives, which lead to improvement in UE UL performance and/or UL system performance; and v) a combination of several objectives as described above

The determination of the precoder for UL transmission with multiple antennas can be done by the serving node or by any node which has or can acquire or determine precoder information about the multiple cells or UE radio transmission characteristics. Optionally, the UL interference received at one or more uplink radio nodes involved in multi-cell operation may also be used. The disclosed methods of these embodiments can also be implemented in the UE. In this case the algorithm for precoder determination based on received information (e.g. recommended precoder for neighboring nodes) can also be pre-defined.

According to certain aspects, only a subset of the cells or links involved in multi-cell/multi-link operation are involved when determining the precoder for UL transmission.

According to another aspect, all cells or links involved in multi-cell/multi-link operation for the UE are involved when determining the precoder for UL transmission.

The selection of radio nodes, for instance, when a UE is served by multiple cells such as in multi-cell/multi-link operation, can be done by a centralized or a distributed mechanism or even by the UE itself. In certain embodiments, the network may first decide which cells should be involved in the precoder selection process.

For instance, in an embodiment of the present disclosure, the decision is made at a centralized node or at the serving node, such as an RNC, serving base station, or serving eNode B in LTE, for example, based on the information delivered by each of the base stations involved in the multi-cell operation for the UE. This information may include, for example, a recommended precoder.

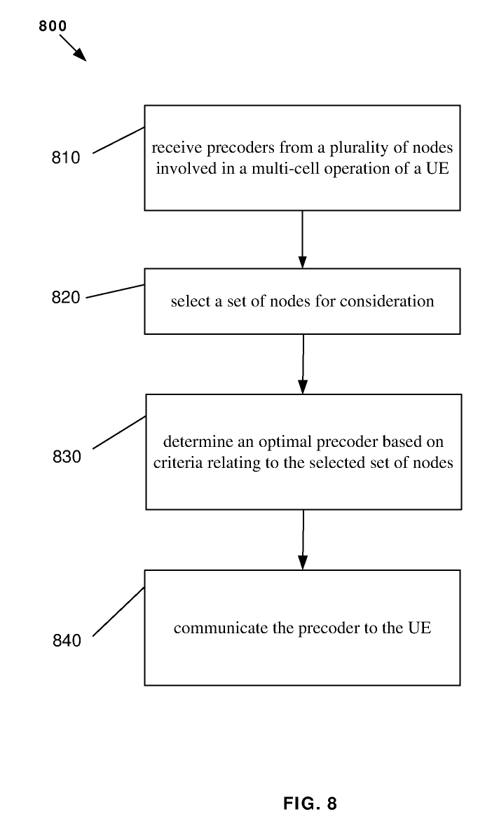

Referring now to FIG. 8, a flow 800 illustrating a process for adaptively selecting a precoder is shown.

In step 810, the serving node receives precoders from a plurality of nodes involved in a multi-cell operation of a UE.

In step 820, the serving node selects a subset of these nodes for consideration in determining an optimized precoder. This selection may be based, for instance, on the precoders received from the nodes or an operating scenario of the UE.

In step 830, the serving node determines an optimal precoder based on criteria relating to the selected set of nodes. This determination may be made, for example, using any number (or combination) of the techniques disclosed herein for optimizing precoders.

In step 840, the precoder is communicated to the UE.

When implementing a more distributed mechanism, each network node (e.g. Base station, relay etc.) may assess its uplink signal quality for signals transmitted by the UE and determine whether it should be included or excluded. In this embodiment, the node essentially votes itself in or out of the subset and as a candidate for precoder (e.g. TPI) optimization selection. Methods for assessing the signal quality may be based, for example, on any suitable measurement, such as SINR, SNR, or BLER. An advantage of a distributed scheme is the reduction or avoidance backhaul signaling, lower latency, and a reduction in the amount of centralized processing needed. Each network node may also optionally inform other network nodes of its decision as to whether or not it is included or excluded from the subset involved for precoder selection.

In certain UE-based embodiments of the method, all (1, 2, . . . , N) cells involved in SHO/multi-cell operation of the UE signal their own recommended precoder to the UE. The UE may then autonomously select one of the N precoders. The selection can be based on one or more criteria which can be pre-defined. For example, the UE may select the precoders of the N precoders, which are most similar. In another example, the selected precoder may be selected such that it leads to smallest change in the beam direction compared to the precoder used during the previous UL multi-antenna transmission.

According to certain aspects, once the active set for TPI selection is established, each network node in the active set can determine a TPI based on pre-defined criteria and signal its selected TPI to the serving network node, for instance, via RNC if the cells are not in the same base station. If cells in the active set are in the same base station, then the serving cell can obtain the TPIs internally from each of the other cells. TPI information from other base stations may preferably be based on long term measurements, for instance, of over 100 ms or longer. Otherwise, there may be a significant increase in overhead signaling.

The decision on the optimal TPI choice for the SHO (or alternatively, UL CoMP) can be made at the RNC or at one of the involved nodes. This may be understood as deriving TPI=f₃(TPI₁, TPI₂, . . . , TPI_{K}) where

$${f}_{3} ( {TPI}_{1} , … , {TPI}_{K} ) = arg ( {max}_{TPI ∈ C} α {\sum }_{j = 1}^{K} {P}_{ASTS , j} ( TPI ) - β {\sum }_{i = 1}^{N} {P}_{victim\_i} ( TPI ) ) \qquad ( 6 )$$

and where the set C={TPI₁, TPI₂, . . . , TPI_{K}} includes selected TPIs from base stations or cells in the active set, and P_{ASTS,j}(TPI) is the power of the received UE signal as a function of TPI at the j^{th} active set base station or cell.

In LTE, there is no SHO. For UL CoMP with UL MIMO/CLTD for both LTE and HSPA, the above descriptions regarding centralized and distributed mechanisms apply. Each cell in the CoMP active set computes TPI. Subsequently, the serving cell derives TPI considering impact on other cells.

In certain embodiments, the methods and techniques above can be combined in order to select the optimum TPI value.

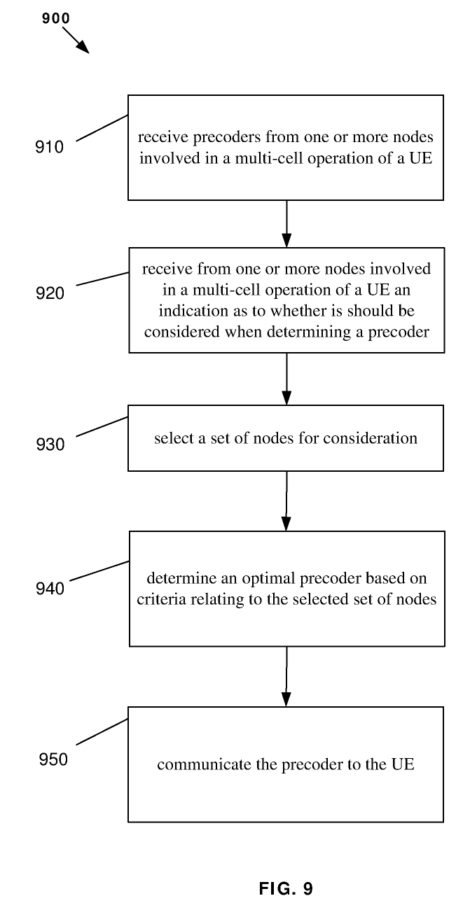

Referring now to FIG. 9, a flow 900 illustrating a process for selecting a precoder is shown.

In step 910, the serving node receives precoders from one or more nodes involved in a multi-cell operation of a UE.

In step 920, the serving node optionally receives from one or more nodes an indication as to whether that node should be considered when determining an optimized precoder.

In step 930, the serving node selects a subset of these nodes for consideration in determining an optimized precoder. This selection may be based, for instance, on the received precoders and/or one or more operating scenario of the UE.

In step 940, the serving node determines an optimal precoder based on criteria relating to the selected set of nodes. This determination may be made, for example, using any number (or combination) of the techniques disclosed herein for optimizing precoders.

In step 950, the precoder is communicated to the UE.

According to embodiments of the disclosure, the selected precoder (e.g. TPI, PMI etc.) is signaled to the UE by a network node, such as the serving network node. As described earlier, in some embodiments, the UE may receive more than one precoder information, which may be associated with different cells in the UL. For example, the UE may receive precoder information for UL transmission using UL multi-antennas for the current serving cell and for the new serving cell in the case of cell change.

Upon receiving the precoder information the UE may determine whether the information is related to the current serving cell/link or serving cell/link after cell change or may apply for any cell. The UE then uses the received precoder to adjust the weights of the UL signals to be transmitted with UL multi-antenna. The adjustment may include, for example, adjustment of the amplitude and phases of the UL signals. The UE then performs the UL signal transmission to the serving cell(s) involved in multi-cell operation.

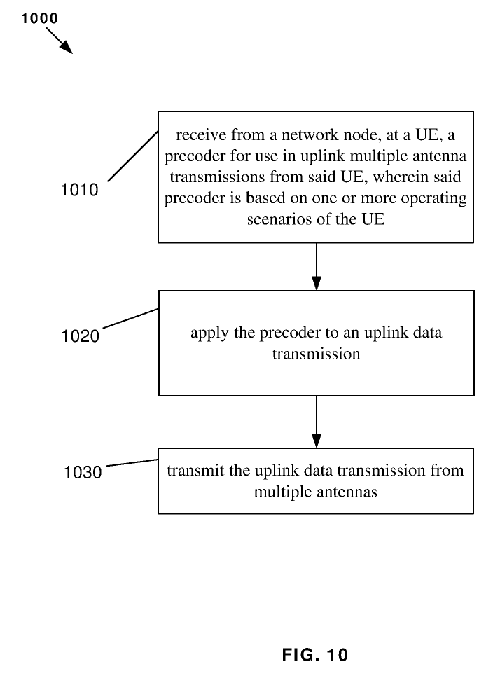

Referring now to FIG. 10, a flow 1000 illustrating a process for improving uplink transmission properties in a communication network is shown.

In step 1010, a UE receives from a network node a precoder for use in uplink multiple antenna transmissions from the UE. This precoder is based on one or more operating scenarios of the UE, and may be derived using any number (or combination) of the techniques and methods disclosed herein. For instance, it may be determined by implementing one or more of the methods outlined in FIGS. 5-9 of the present disclosure.

In step 1020, the UE applies the precoder to an uplink data transmission.

In step 1030, the UE transmits the uplink data transmission from multiple antennas of UE.

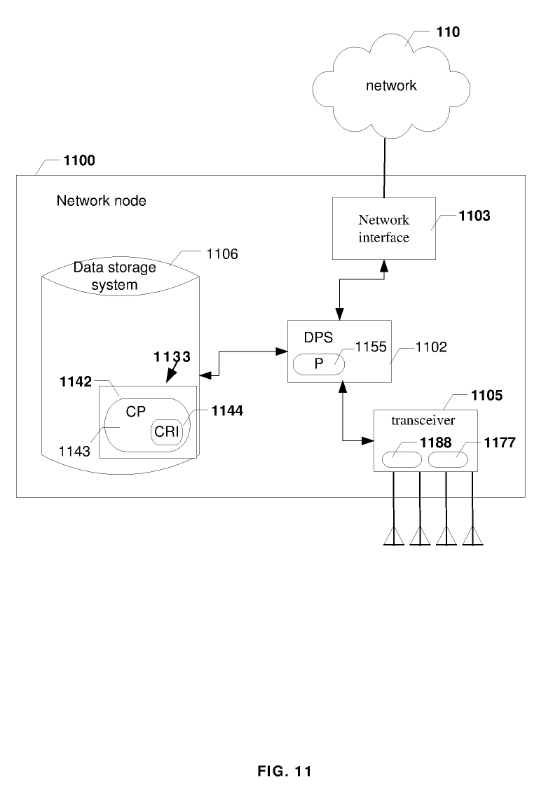

FIG. 11 is a block diagram of an embodiment of a network node 1100 (e.g., a base station). As shown in FIG. 11, network node 1100 may include: a data processing system (DPS) 1102, which may include one or more processors 1155 (e.g., a general purpose microprocessor) and/or one or more circuits, such as an application specific integrated circuit (ASIC), field-programmable gate arrays (FPGAs), and the like; a network interface 1103 for use in connecting network node 1100 to a network 110; a transceiver 1105, comprising a transmitter 1177 and a receiver 1188, coupled to a plurality of antennas (e.g., four antennas as shown) for transmitting data wirelessly and receiving data wirelessly; and a data storage system 1106, which may include one or more non-volatile storage devices and/or one or more volatile storage devices (e.g., random access memory (RAM)). In embodiments where network node 1100 includes a processor 1155, a computer program product (CPP) 1133 may be provided. CPP 1133 includes a computer readable medium (CRM) 1142 storing a computer program (CP) 1143 comprising computer readable instructions (CRI) 1144. CRM 1142 may be a non-transitory computer readable medium, such as, but not limited, to magnetic media (e.g., a hard disk), optical media (e.g., a DVD), memory devices (e.g., random access memory), and the like. In some embodiments, the CRI of computer program 1143 is configured such that when executed by data processing system 1102, the CRI causes the network node 1100 to perform steps described above (e.g., steps described above with reference to the flow chart shown in FIGS. 5-9). In other embodiments, network node 1100 may be configured to perform steps described herein without the need for code. That is, for example, data processing system 1102 may consist merely of one or more ASICs. Hence, the features of the embodiments described herein may be implemented in hardware and/or software.

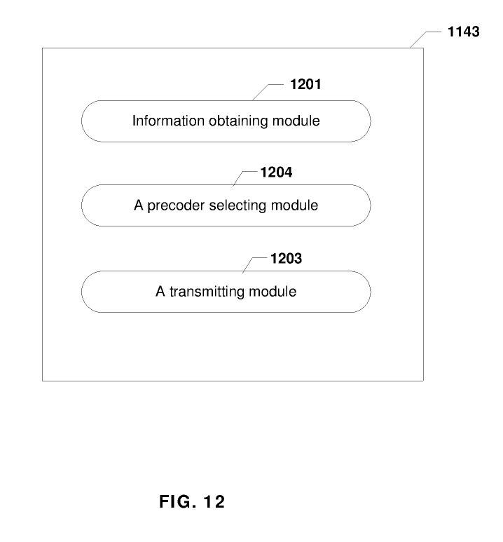

Referring now to FIG. 12, FIG. 12 illustrates modules that may be part of CP 1143. As shown in FIG. 12, CP 1143 may include: i) an information obtaining module 1201 for obtaining information indicating an operating scenario of a user equipment, UE, served by the network node, wherein the UE includes a plurality of antennas and the UE is configured to transmit uplink, UL, signals using the plurality of antennas; ii) a precoder selecting module 1204 for selecting a precoder that is optimized for UL multiple antenna transmission based on at least the indicated operating scenario; and iii) a transmitting module 1203 for using transmitter 1177 to communicate the precoder to the UE.

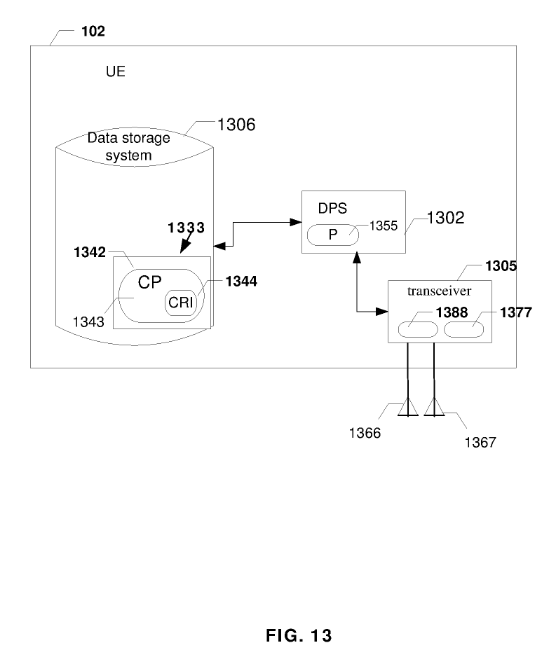

FIG. 13 is a block diagram of an embodiment of UE 102. As shown in FIG. 13, UE 102 may include: a data processing system (DPS) 1302, which may include one or more processors 1355 (e.g., a general purpose microprocessor) and/or one or more circuits, such as an application specific integrated circuit (ASIC), field-programmable gate arrays (FPGAs), and the like; a network interface 1303 for use in connecting UE 102 to a network 130; a transceiver 1305, comprising a transmitter 1377 and a receiver 1388, coupled to a plurality of antennas (e.g., antennas 1366 and 1367) for transmitting data wirelessly and receiving data wirelessly; and a data storage system 1306, which may include one or more non-volatile storage devices and/or one or more volatile storage devices (e.g., random access memory (RAM)). In embodiments where UE 102 includes a processor 1355, a computer program product (CPP) 1333 may be provided. CPP 1333 includes a computer readable medium (CRM) 1342 storing a computer program (CP) 1343 comprising computer readable instructions (CRI) 1344. CRM 1342 may be a non-transitory computer readable medium, such as, but not limited, to magnetic media (e.g., a hard disk), optical media (e.g., a DVD), memory devices (e.g., random access memory), and the like. In some embodiments, the CRI of computer program 1343 is configured such that when executed by data processing system 1302, the CRI causes the UE 102 to perform steps described above (e.g., steps described above with reference to the flow chart shown in FIG. 10). In other embodiments, UE 102 may be configured to perform steps described herein without the need for code. That is, for example, data processing system 1302 may consist merely of one or more ASICs. Hence, the features of the embodiments described herein may be implemented in hardware and/or software.

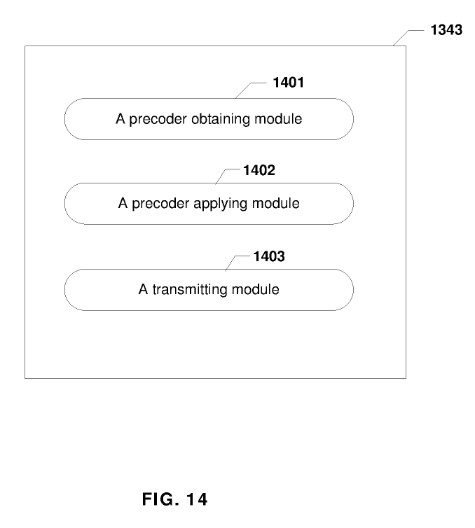

Referring now to FIG. 14, FIG. 14 illustrates modules that may be part of CP 1343. As shown in FIG. 14, CP 1343 may include: i) a precoder obtaining module 1401 for obtaining a precoder for use in uplink multiple antenna transmissions from said UE, wherein said precoder is based on one or more operating scenarios of said UE; ii) a precoder applying module 1402 for applying said precoder to an uplink data transmission; and iii) a transmitting module 1403 for using transmitter 1377 to transmit the uplink data transmission using at least two transmit antennas 1366, 1367.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-32. (canceled)

33. A method performed by a network node for improving uplink transmission properties in a communication network, comprising:
obtaining information indicating an operating scenario of a user equipment, UE, served by the network node, wherein the UE includes a plurality of antennas and the UE is configured to transmit uplink, UL, signals using the plurality of antennas;
selecting a precoder that is optimized for UL multiple antenna transmission based on at least the indicated operating scenario; and
communicating the precoder to the UE;
wherein the information indicating an operating scenario comprises information indicating one or more of: i) a deployment characteristic on which the UE operates, ii) a cell change scenario, iii) a radio transmission characteristic of the UE, iv) a number of links that are involved in UL transmissions from the UE, and v) a type of service used by the UE.

34. The method of claim 33, wherein selecting the precoder is further based on information received from another network node, wherein the information comprises information identifying one or more of: a recommended precoder to be used and precoders used in other radio nodes involved in UL transmissions from the UE.

35. The method of claim 33, wherein the information indicating an operating scenario comprises information indicating a deployment characteristic on which the UE operates.

36. The method of claim 35, wherein the information indicating a deployment characteristic on which the UE operates comprises information indicating a deployment characteristic of a cell on which the UE operates, the deployment characteristic of the cell being one of: the size of a cell served by a radio node serving the UE, the receiver sensitivity of the radio node, a power class of the radio node, a power level of the radio node, UE location in the cell, and UE radio measurements.

37. The method of claim 33, wherein the information indicating an operating scenario comprises information indicating a radio transmission characteristic of the UE.

38. The method of claim 37, wherein the information indicating a radio transmission characteristic of the UE comprises one or more of: i) information indicating a transmit power of the UE and ii) information pertaining to a power source used to power the UE.

39. A network node for improving uplink transmission properties in a communication network, the network node being adapted to:
obtain information indicating an operating scenario of a user equipment, UE, served by the network node, wherein the UE includes a plurality of antennas and the UE is configured to transmit uplink, UL, signals using the plurality of antennas;
select a precoder that is optimized for UL multiple antenna transmission based on at least the indicated operating scenario; and
communicate the precoder to the UE;
wherein the information indicating an operating scenario comprises information indicating one or more of: i) a deployment characteristic on which the UE operates, ii) a cell change scenario, iii) a radio transmission characteristic of the UE, iv) a number of links that are involved in UL transmissions from the UE. and v) a type of service used by the UE.

40. The network node of claim 39, wherein:
the information indicating an operating scenario comprises information indicating a deployment characteristic on which the UE operates,
the information indicating a deployment characteristic on which the UE operates comprises information indicating a deployment characteristic of a cell on which the UE operates, the deployment characteristic of the cell being one of: the size of a cell served by a radio node serving the UE, the receiver sensitivity of the radio node, a power class of the radio node, a power level of the radio node, UE location in the cell, and UE radio measurements.

41. A user equipment, UE, for improving uplink transmission properties in a communication network, the UE being adapted to:
obtain a precoder for use in uplink multiple antenna transmissions from said UE, wherein said precoder is based on information indicating an operating scenario of said UE;
apply said precoder to an uplink data transmission; and
transmit the uplink data transmission using at least two transmit antennas.

42. The UE of claim 41, wherein:
the information indicating the operating scenario of said UE comprises information indicating a deployment characteristic on which the UE operates, and
the information indicating a deployment characteristic on which the UE operates comprises information indicating a deployment characteristic of a cell on which the UE operates, the deployment characteristic of the cell being one of: the size of a cell served by a radio node serving the UE, the receiver sensitivity of the radio node, a power class of the radio node, and a power level of the radio node.

43. The UE of claim 41, wherein the information indicating the operating scenario of said UE comprises information indicating a radio transmission characteristic of the UE.

44. The UE of claim 43, wherein the information indicating the radio transmission characteristic of the UE comprises one or more of: i) information indicating a transmit power of the UE and ii) information pertaining to a power source used to power the UE.

45. A network node for improving uplink transmission properties in a communication network, comprising: a processor; and a memory, said memory containing instructions executable by said processor, whereby said network node is operative to:
obtain information indicating an operating scenario of a user equipment, UE, served by the network node, wherein the UE includes a plurality of antennas and the UE is configured to transmit uplink, UL, signals using the plurality of antennas;
select a precoder that is optimized for UL multiple antenna transmission based on at least the indicated operating scenario; and
communicate the precoder to the UE;
wherein the information indicating an operating scenario comprises information indicating one or more of: i) a deployment characteristic on which the UE operates, ii) a cell change scenario, iii) a radio transmission characteristic of the UE, iv) a number of links that are involved in UL transmissions from the UE, and v) a type of service used by the UE.

46. The network node of claim 45, wherein:
the information indicating an operating scenario comprises information indicating a deployment characteristic on which the UE operates;
the information indicating a deployment characteristic on which the UE operates comprises information indicating a deployment characteristic of a cell on which the UE operates, the deployment characteristic of the cell being one of: the size of a cell served by a radio node serving the UE, the receiver sensitivity of the radio node, a power class of the radio node, a power level of the radio node, UE location in the cell, and UE radio measurements.

47. The network node of claim 45, wherein the information indicating an operating scenario comprises information indicating a radio transmission characteristic of the UE.

48. The network node of claim 47, wherein the information indicating a radio transmission characteristic of the UE comprises one or more of: i) information indicating a transmit power of the UE and ii) information pertaining to a power source used to power the UE.

49. A user equipment, UE, for improving uplink transmission properties in a communication network, comprising: a first transmit antenna; a second transmit antenna; a processor; and a memory, said memory containing instructions executable by said processor, whereby said UE is operative to:
obtain a precoder for use in uplink multiple antenna transmissions from said UE, wherein said precoder is based on information indicating an operating scenario of said UE;
apply said precoder to an uplink data transmission; and
transmit the uplink data transmission using the first and second transmit antennas.

50. The UE of claim 49, wherein:
the information indicating the operating scenario comprises information indicating a deployment characteristic on which the UE operates; and
the information indicating the deployment characteristic on which the UE operates comprises information indicating a deployment characteristic of a cell on which the UE operates, the deployment characteristic of the cell being one of: the size of a cell served by a radio node serving the UE, the receiver sensitivity of the radio node, a power class of the radio node, and a power level of the radio node.

51. The UE of claim 49, wherein the information indicating the operating scenario comprises information indicating a radio transmission characteristic of the UE.

52. The UE of claim 51, wherein the information indicating the radio transmission characteristic of the UE comprises one or more of: i) information indicating a transmit power of the UE and ii) information pertaining to a power source used to power the UE.
